(19) United States
(12) Patent Application Publication
(10) Pub. No.: US 2013/0232045 A1
(43) Pub. Date: Sep. 5, 2013

(54) Automatic Detection Of Fraud And Error Using A Vector-Cluster Model

(71) Applicants: Amy Tai, Tulsa, OK (US); Dane Roberts, San Carlos, CA (US); Appala Jagadesh Padala, Irving, TX (US); Bhaskar Ghosh, Pleasanton, CA (US)

(72) Inventors: Amy Tai, Tulsa, OK (US); Dane Roberts, San Carlos, CA (US); Appala Jagadesh Padala, Irving, TX (US); Bhaskar Ghosh, Pleasanton, CA (US)

(73) Assignee: ORACLE INTERNATIONAL CORPORATION, Redwood Shores, CA (US)

(21) Appl. No.: 13/411,597

(22) Filed: Mar. 4, 2012

(51) Int. Cl. G06Q 40/00

(52) U.S. Cl. 705/35

(57) ABSTRACT

One or more computers retrieve records of transactions to be analyzed together. Each record identifies a date of a transaction, an amount of the transaction, a person associated with the transaction, and a category into which the transaction is classified. The one or more computers automatically prepare in computer memory, a set of tuples (also called “vectors”) corresponding to a set of persons identified in the retrieved records. Each tuple corresponds to one person, and each tuple includes at least one number representing a count within each category, of transactions classified therein, e.g. total number of cash transactions in category X. Then, the one or more computers automatically identify a subset of outliers, e.g. by grouping the tuples into clusters using k-means clustering, followed by marking in memory an indication of inappropriateness of any transaction that had been included in the count of a tuple now identified to be outlier.

### BACKGROUND

When employees in an organization submit requests for reimbursement of expenses, e.g. for travel and entertainment (T&E), the expense-reimbursement requests need to be analyzed by the employer, for fraud and errors. A number of organizations use manual or spreadsheet based methodologies (e.g. using EXCEL available from MICROSOFT CORPORATION) to identify T&E requests that may be fraudulent or contain errors (e.g. typographical mistakes). For example, a request for reimbursement of expense for meals may be flagged in a spreadsheet, if the amount being requested (say $4,590) exceeds a preset limit thereon, e.g. $100. Such an expense-reimbursement request may arise when a decimal point is omitted from the amount spent, either deliberately or inadvertently. Such spread-sheet based prior art methods can be useful when the number of expense-reimbursement requests is relatively small, e.g. 100 requests. But when the volume of such expense-reimbursement requests becomes large, use of a spread-sheet becomes burdensome. Therefore, a tool is needed to analyze a large number of expense-reimbursement transactions together, to detect fraud and errors.

US Patent Publication 2008/0109272 by Sheopuri et al. is incorporated by reference herein in its entirety as background. US Patent Publication 2008/0109272 describes a computer-implemented method of applying statistics to generate an estimate of a probability of fraud for a particular claim (e.g. for an expense), updating the estimate using decision making under uncertainty that is based at least in part on at least one type of additional information, applying game theory to the updated estimate to model strategic behavior between economic agents, and generating a recommendation to audit or not audit the particular claim. However, recommendations for audit of the type described above can be difficult to justify, because the process for making recommendations is based on statistics and game theory.

U.S. Pat. No. 7,716,135 by Angell is incorporated by reference herein in its entirety as background. U.S. Pat. No. 7,716,135 describes a computer-implemented method for detecting fraud. An initial model is developed using historical data, such as demographic, psychographic, transactional, and environmental data, using data-driven discovery techniques, such as data mining, and may be validated using additional statistical techniques. The outliers (or noise) within the data models determine appropriate initial control points that define an ‘electronic fence’. A fraud detection mechanism validates updated data using data mining and statistical methods. The ‘electronic fence’ is refined based on the newly acquired data. The process of refining and updating the data models is iterated until a set of limits is achieved. When the data models reach a steady state, the models are treated as static models. Data points (and a subset therein identified as outliers) in U.S. Pat. No. 7,716,135 appear to be transactions themselves. This interpretation of data points in U.S. Pat. No. 7,716,135 is supported throughout the disclosure, including, for example, column 9, lines 24-32 which state “Outlier analysis is used to find records where some of the attribute values are quite different from the expected values. For example, outlier analysis may be used to find transactions with unusually high amounts or unusual geographic locations. Outliers are often viewed as significant data points. For example, if an account holder never makes a credit card purchase over $1000 and then a credit card purchase of $5000 occurs, this could be an indication of fraudulent activity.” However, such methods do not appear to address behavior of a person that may cumulatively indicate fraud across multiple transactions.

A paper entitled “Analytics for Audit and Business Controls in Corporate Travel & Entertainment” by lyengar et al, Sixth Australasian Data Mining Conference (AusDM 2007), is incorporated by reference herein in its entirety as background. The emphasis of this paper appears to be on detecting repeated, out-of-the-norm behaviors, as opposed to single instance occurrences. This paper describes two statistical models that are based on domain knowledge in the form of templates that represent classes of fraud and abuse. A first model seeks to detect employees with significantly high tip claims (normalized by location where the tip expense was incurred), by a formulation of a Likelihood Ratio Test (LRT) to scan for clusters of abnormality that stand out within the entire space of data considered. In this first model, this paper describes looking for those employees who are trying to exploit the receipt limits by claiming expenses just below them. In a second model, the above-described paper seeks to detect employees with excessive (or insufficient) counts for specific events similar to the use of LRT in the first model, although based on a Poisson model to model event counts that are proportional to known opportunities with possible categorical covariates. In this second model, this paper describes seeking to detect approvers who are approving exceptions to a business rule excessively, e.g. excessively approving exceptions to upper limits on hotel room rates.

Both models in the above-described paper appear to be based on Monte Carlo experiments to compute p-values. Use of Monte Carlo experiments to identify employees to be audited can be difficult to justify, because the process is based on statistics and game theory. Moreover, such methods do not appear to address behavior of a person that may cumulatively indicate fraud across multiple categories, as described below.

### SUMMARY

One or more computers are programmed in accordance with the invention to retrieve records of transactions that are to be analyzed together. Each record identifies a date of a transaction, an amount of the transaction, a person associated with the transaction, and a category into which the transaction is classified (also called “type” of expense). Examples of different types (i.e. categories) of expenses are meals, mileage, books, tips, and cab-fare.

The one or more computers automatically prepare in computer memory, a set of tuples for a corresponding set of persons who are identified in the retrieved records as being associated with the transactions. Each tuple (also called vector) for a corresponding person includes a group of numbers that are derived from transactions in a corresponding group of categories (or types) that have been associated with that person. Each tuple (or vector) provides a multi-category indication of a single person's behavior, cumulatively over different transactions.

After the set of tuples are formed, for the set of persons identified in the retrieved records, the one or more computers automatically identify a subset of tuples (vectors), by analysis of the set of tuples to detect outliers. Any data mining technique may be used to identify the subset (also called “outlier subset”), depending on the embodiment. After the outlier subset is identified, the one or more computers automatically mark in computer memory, an indication of inappropriateness of one or more transactions on which is based a number in a tuple identified in the outlier subset.

One specific data mining technique that is used in some embodiments forms clusters of tuples (e.g. using k-means clustering or another clustering method). After clusters are formed, whichever cluster has the fewest tuples may be identified as the outlier subset. The just-described combination, wherein an outlier subset is identified by a clustering method, from among a set of vectors that correspond to persons, is also referred to herein as a “vector-cluster” model.

A vector-cluster model of the type described above may be used to identify fraud and errors in expense-reimbursement requests in some embodiments, although other embodiments may use the vector-cluster model with other transactions.

### BRIEF DESCRIPTION OF THE FIGURES

FIG. 1 illustrates, in a high-level flow chart, a method performed by a processor in a computer 100, in accordance with the invention.

FIG. 2 illustrates, in a block diagram, computer 100 of FIG. 1 in accordance with the invention including a business object containing records 151XA-151ZN to be analyzed, and a memory that includes a transactions analyzer 110 to analyze the records 151XA-151ZN.

FIG. 3 illustrates, in a graph, a tuple (also called “vector”) of numbers v1, v2, . . . v9 formed for each person identified in a transaction, by a computer 100 in some embodiments of the invention.

FIG. 4A illustrates in a low-level flow chart, the method of FIG. 1, as implemented by some embodiments of the invention.

FIG. 4B illustrates rows of expense-reimbursement requests in the first quarter of 2011 that are retrieved on performance of act 411 of FIG. 4A in an example.

FIG. 4C illustrates, in a graph, a vector for an employee whose identifier is 3994596 identified in the expense-reimbursement requests of FIG. 4B.

FIGS. 5A and 5B illustrate, in block diagrams, hardware and software portions of a computer that performs the method illustrated in FIG. 1.

### DETAILED DESCRIPTION

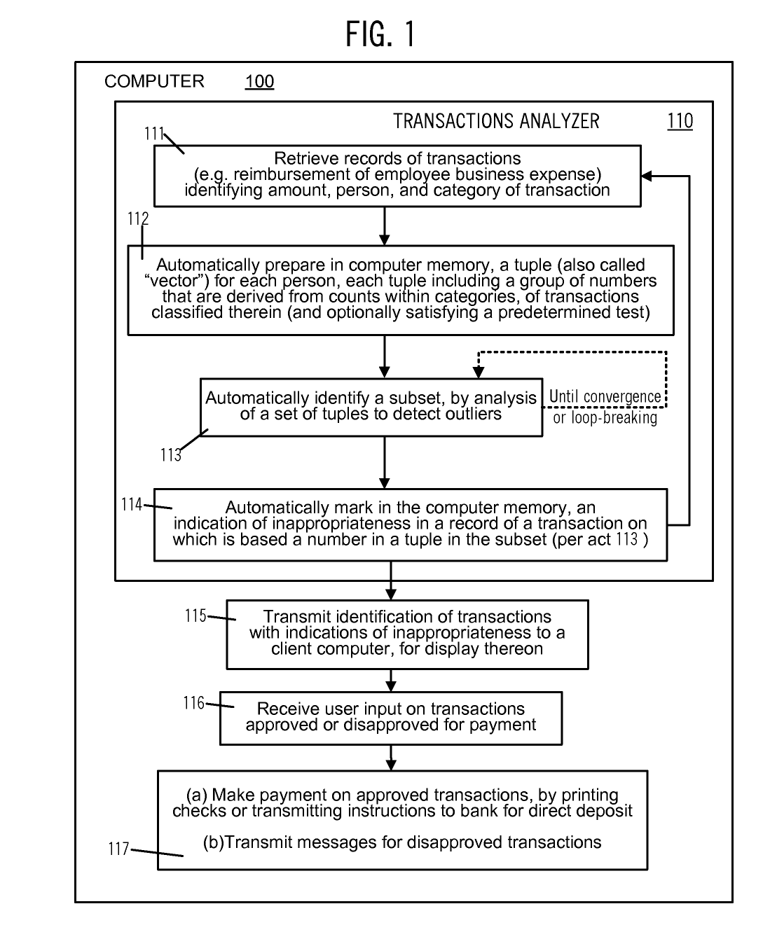

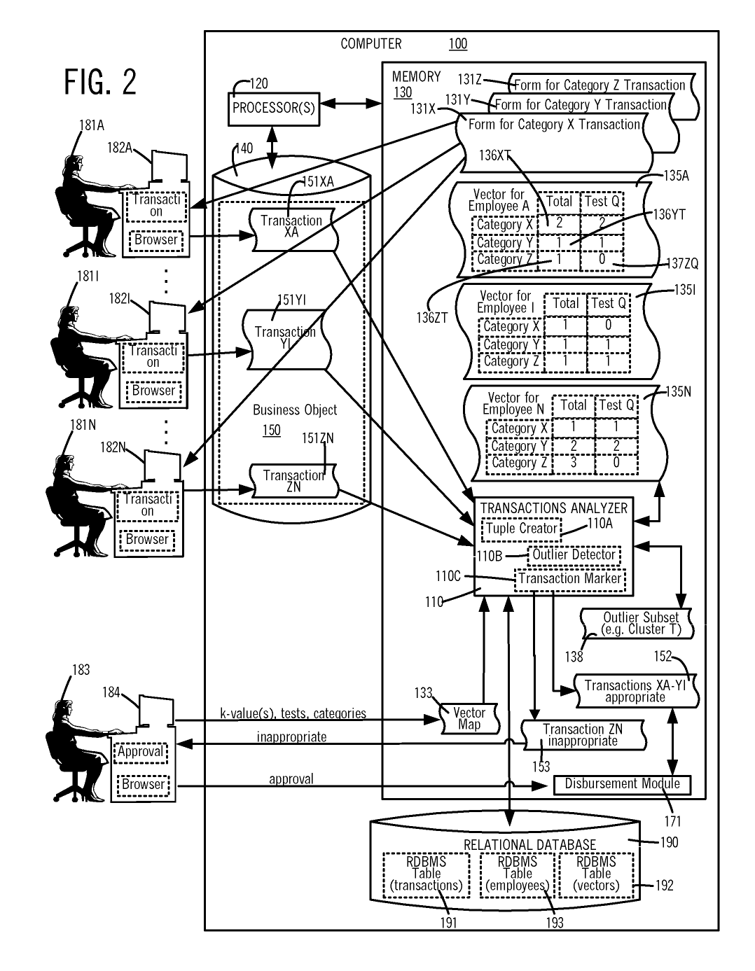

A processor 120 in a computer 100 is programmed with software (called “transactions analyzer”) 110 in accordance with the invention to perform a method of the type illustrated in FIG. 1, e.g. to retrieve in act 111, records of transactions which are to be analyzed. Records 151XA-151ZN (FIG. 2) of transactions (such as petty cash expenses) may be initially created in client computers 182A-182N by persons 181A-181N via input devices such as a keyboard and/or a mouse (not shown). Client computers 182A-182N supply the records 151XA-151ZN via a wired or wireless link to computer 100 and on receipt the records 151XA-151ZN are stored in a business object 150 in one or more non-volatile storage media (such as a hard disk) 140, in the normal manner. Records 151XA-151ZN may thereafter be stored in an RDBMS table 191 in a relational database 190 accessible to computer 100. Regardless of where and how they are stored, records 151XA-151ZN are retrieved act 111 for use in analysis together as described below.

Records 151XA-151ZN retrieved in act 111 may identify, for example details of corresponding transactions therein such as (1) an identifier of a person (such as an employee identifier and/or first name, last name) associated with the transaction, (2) the amount of the transaction, (3) and a category into which the transaction is classified (indicative of a type of the transaction). For example, a record 151YI may identify the following details of a particular transaction: (1) Jon Doe Employee ID 374, (2) $32.35, and (3) Meals. Such a record 151Y1 may optionally identify additional details, such as (4) a date on which the transaction was performed, (5) a vendor to whom payment was made (6) whether the payment was in cash or credit and (7) any notes or description of the transaction.

A person is normally associated with a transaction as noted above, although the association may vary depending on the embodiment (e.g. depending on the transactions analyzer itself). In some embodiments, transactions analyzer 110 is implemented to analyze requests for reimbursement of travel and entertainment (T&E) expenses, and the person identified in records 151XA-151ZN is an employee that incurred an expense and to whom reimbursement is to be made. In other embodiments, transactions analyzer 110 is implemented to analyze sales order discounts, and the person identified in records 151XA-151ZN is an employee that performed a sale. In still other embodiments, transactions analyzer 110 is implemented to analyze journal entries that are manually entered via accounting software, and the person identified in records 151XA-151ZN is an employee that made a journal entry.

Record 151Y1 may additionally include more details that depend on the category (also called “type”) of the transaction. As a first example, for a category of expenses for “Meals”, additional details may include (8) amount of tip and (9) name of a guest; as a second example, for the category “Mileage”, additional details may include (8) Odometer Reading at start of trip, (9) Odometer Reading at end of trip; and as a third example, for the category “Books”, additional details may include (8) Tax, and (9) Cost of Shipping. Such details in each record 151YI may be initially entered into fields of forms 131X-131Z that are available in memory 130 (FIG. 2) for presentation to persons 181A-181N by respective computers 182A-182N, e.g. via a browser.

After creation, records 151XA-151ZN are retrieved (as per act 111 in FIG. 1) and then used (in act 112 performed in a tuple creator 110A) to prepare a number of tuples (also called “vectors”) 135A-135N in computer memory 130 (FIG. 2), with one tuple 135I for each person 181I who is identified in one of records 151XA-151ZN (as retrieved in act 111 of FIG. 1). Each tuple 135I includes a group of numbers that are derived from counts within categories, of transactions classified therein. For example, total number of cash transactions in category X is included as one such number in tuple 135I of some embodiments. The just-described number is illustrated in vector 135A by the number 136XT (FIG. 2) for category X, which is just one of several such numbers in tuple 135I. Therefore, tuple 135 may include another such number 136YT for category Y, and still another such number 136ZT for category Z. As noted in the immediately preceding paragraph, examples of categories X, Y and Z are “Meals”, “Mileage” and “Books”.

Depending on the embodiment, one or more numbers included in a tuple 135I may be identified by applying a predetermined test to a transaction, e.g. cash transactions in category X that satisfy a test Q could be a number in tuple 135I, such as number 137ZQ for category Z. One example of test Q is whether a last digit of an amount in a transaction ends in 0, or ends in 5. Note that such a test Q is applicable to all categories A-Z.

Instead of or in addition to such tests that can be applied to all categories, other embodiments of tuple 135I may derive numbers therein based on tests that are specific to each category. For example, a test XQ may check whether an amount of a category X transaction (e.g. a meals transaction) is within a predetermined range based on an approval limit (e.g. $35) for category X. Similarly, another test YQ may check whether the amount of a category Y transaction (e.g. a books transaction) is within a different predetermined range based on another approval limit (e.g. $60) for category Y.

The numbers in a tuple 135I are prepared by computer 100 based on a map 133 in memory 130. Map 133 is initialized to hold, for example, categories X-Z, as well as one or more tests Q, for use in generating the numbers in tuple 135I. Map 133 also specifies an order and location of each number in the tuple 135I. Map 133 is initially created by storing information 132 provided by another person 183 at another computer 184 (connected to computer 100). Person 183 can be anyone authorized within an organization to approve payment for persons 181A-181N associated with the transactions in records 151XA-151ZN. Such tuples 135A-135N, after formation by use of map 133 may be stored in an RDBMS table 192 in relational database 190. When forming tuples (also called vectors) 135A-135N in act 112, an employee identifier in each of records 151XA-151ZN may be checked against an RDBMS table 193 that holds details of employees of an organization, in relational database 190, in some embodiments.

Thereafter, in an act 113 (FIG. 1) performed in an outlier detector 110B, a subset 138 (FIG. 2) is identified from a set of vectors (or tuples) 135A-135N (described above), by analysis of the set to identify one or more outliers. For example, outlier tuples may be identified in the subset for deviating significantly from (or for being inconsistent with) remaining tuples in the set. Depending on the embodiment, subset 138 can be identified by analyzing the set of vectors 135A-135N, using any data mining method that is apparent to the skilled artisan in view of this detailed description. Accordingly, subset 138 may be identified in some embodiments of act 113 by clustering-based methods and in other embodiments of act 113 by proximity-based methods (e.g. based on an average distance to nearest neighbors being largest in the set).

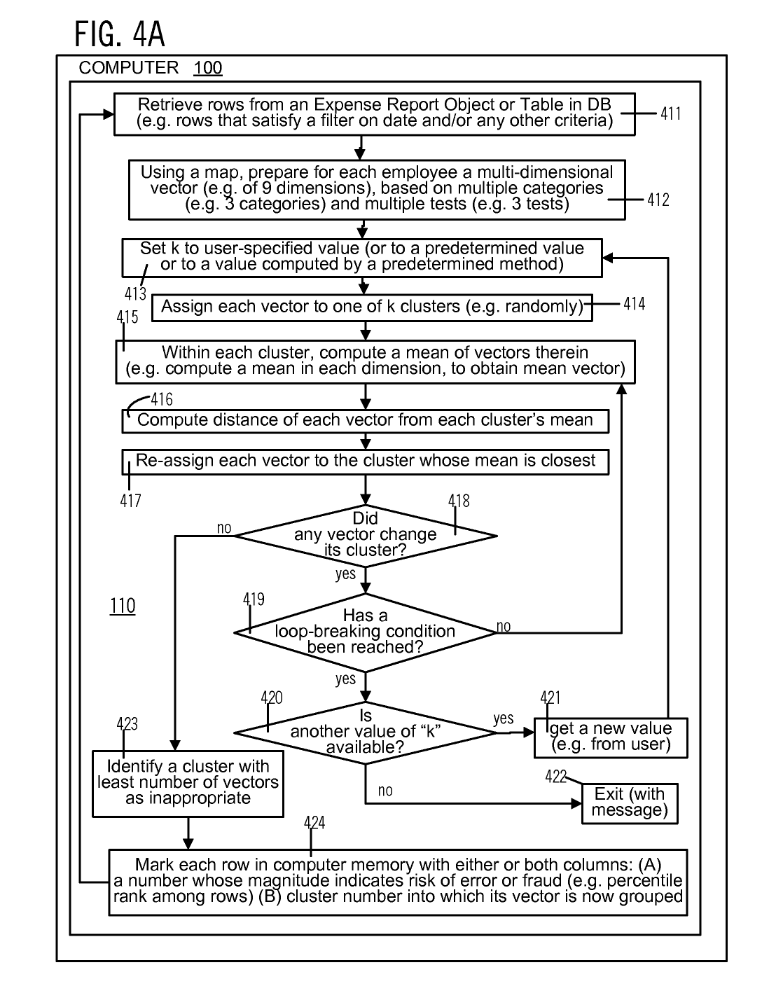

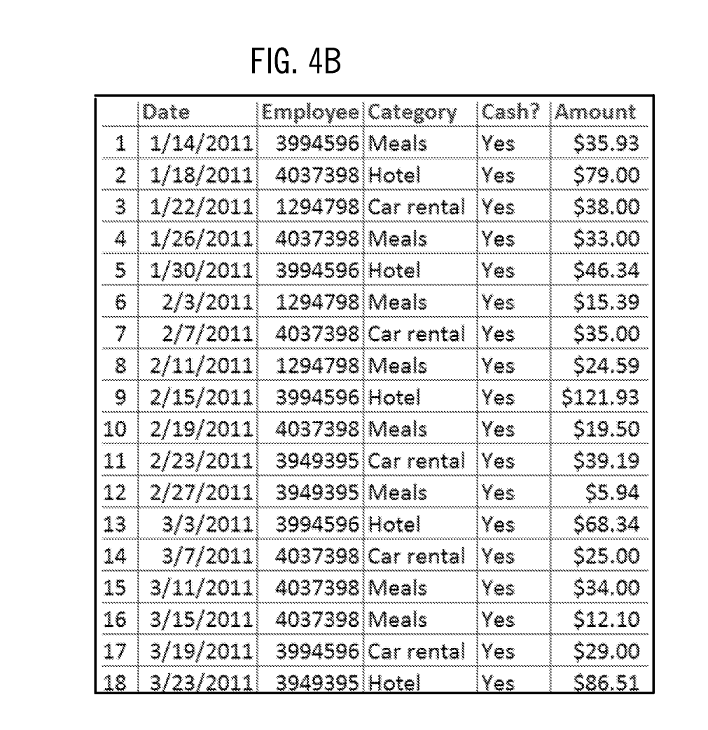

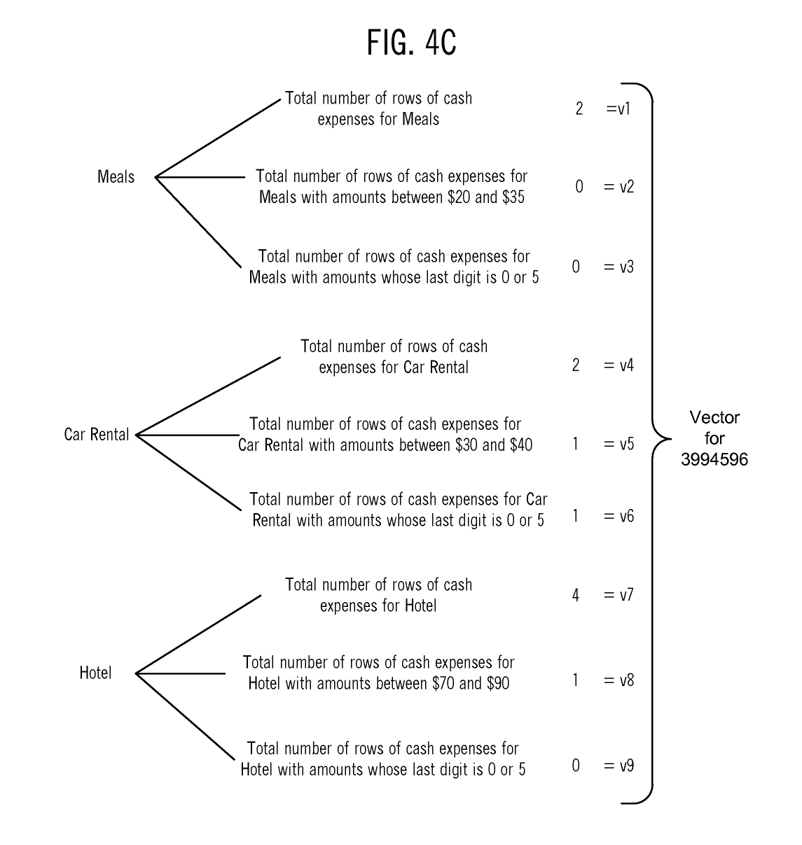

In one example, act 113 is implemented by grouping the tuples 135A-135N (described above) into clusters as described in Chapter 8 entitled “Cluster Analysis: Basic Concepts and Algorithms”, pages 487-568 in a book entitled “Introduction to Data Mining” by Pang-Ning Tan et al published May 2, 2005 by Addison-Wesley that is incorporated by reference herein in its entirety. At the end of such an act 113, a cluster T which has the least number of vectors therein is identified in some embodiments as an outlier subset 138 (for being an outlier relative to other clusters). As noted above, such a clustering technique of act 113 which is used to identify outliers among tuples 135A-135N may be replaced in alternative embodiments, by any other data mining technique. In several embodiments described below, act 113 is implemented to perform a data mining technique called “k-means analysis” as illustrated in FIG. 4A.

Act 113 is followed by an act 114 (FIG. 1) performed in a transaction marker 110C, wherein computer 100 automatically marks in memory 130 (FIG. 2) an indication 153 of inappropriateness of any transaction ZN that had been used to derive a count in a tuple (in subset 138) now identified as an outlier. Depending on the embodiment, indication 153 can be a binary flag (e.g. with value 1 indicating inappropriate and value 0 indicating appropriate) or an integer, or a real number. In several embodiments, the indication 153 is a statistical measure of a degree to which the tuple (derived from the transaction) is an outlier, e.g. indication 153 can be a cluster identifier and/or distance from centroid in k-means analysis.

Subsequently, in an act 115 (FIG. 1), a result generated by transactions analyzer 110, e.g. identification of transaction ZN with an indication of inappropriateness 153, is transmitted to computer 184 for display to person 183. Additionally, or alternatively, the indication of inappropriateness 153 is stored in database 190 for future use. Person 183 may manually approve (or disapprove) a transaction ZN, by providing user input that is received in a disbursement module 171. In some embodiments, disbursement module 171 additionally automatically receives notification of transactions marked with an indication of appropriateness 152 (FIG. 2) from transaction marker 110C, e.g. transactions XZ-YI may be marked by logic in analyzer 110 as being appropriate if they are not cash transactions (as credit card transactions and check transactions are unlikely to be fraudulent because they are easily verified).

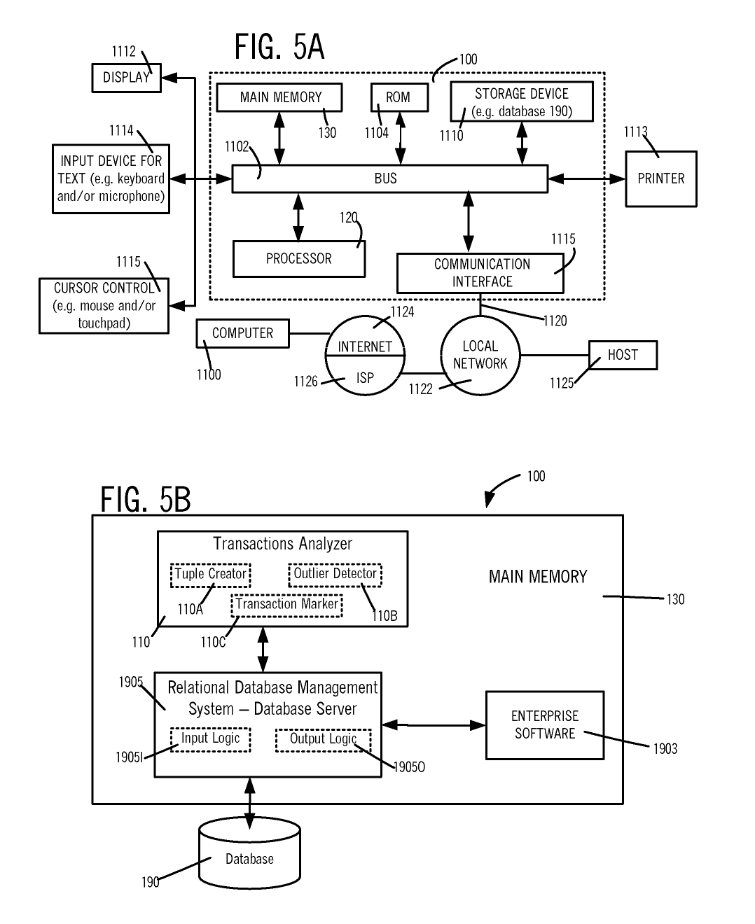

Accordingly, in act 116 (FIG. 1), disbursement module 171 receives input from person 183 identifying any transactions that are approved (or disapproved) for payment. Next, as per act 117 (FIG. 1), disbursement module 171 makes automatic payment of approved transactions, e.g. by printing out a check on printer 1113 (FIG. 5A) or by inter-bank transfer of funds to make a direct deposit (by sending a signal via communication interface 1115 to a computer 1100 (FIG. 5A) in a bank, identifying an amount of money to be paid). Disbursement module 171 may further generate and transmit messages for any transactions that are disapproved, so that the corresponding persons 181A-181N are notified of the decisions (on a display).

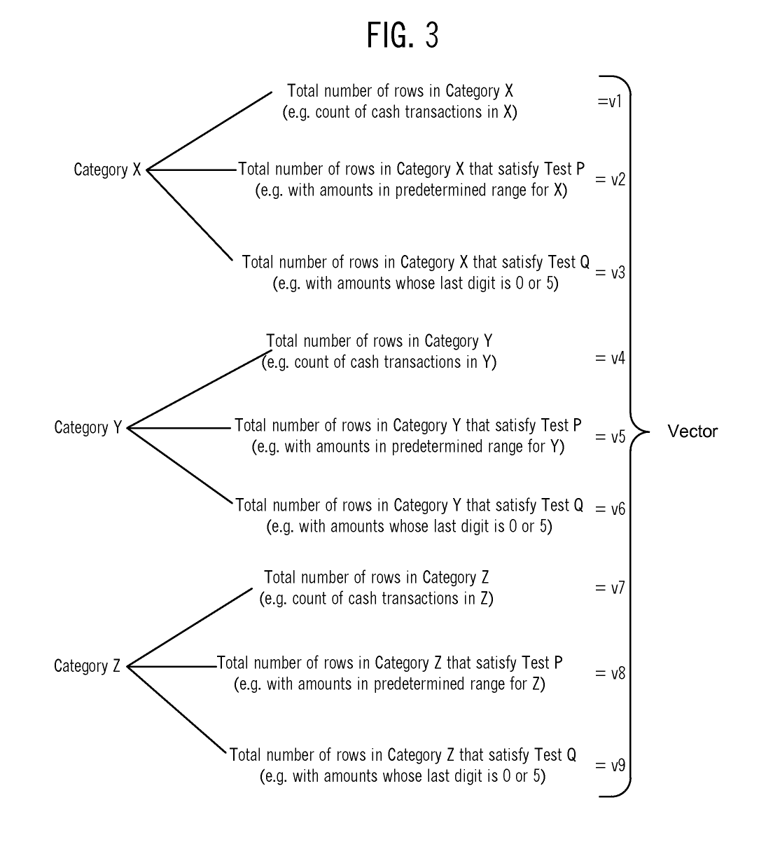

In some embodiments of the type described above, a tuple 135I (FIG. 2) that corresponds to a person 181I (FIG. 2) includes a group of nine numbers v1 . . . v9, as illustrated in FIG. 3. The nine numbers v1 . . . v9 are derived from corresponding counts of transactions associated with person 181I within three categories X, Y and Z by use of a map (also called “vector map”) 133 specified by user 183 of FIG. 2. Map 133 includes identities of categories X, Y and Z selected by user 183 from among a number of categories, for use by transaction analyzer 110 to derive one or more numbers that are included in tuples (vectors) as described above in reference to act 112 (FIG. 1). Vector map 133 also identifies one or more tests Q to be used by transaction analyzer 110 in deriving the numbers in the tuples (vectors), also as described above in reference to act 112 (FIG. 1). A specific manner in which map 133 is used in some embodiments to derive the nine numbers v1 . . . v9 from the transactions in records 151XA-151ZN (FIG. 2) is described below, in reference to FIG. 3.

A first number v1 (FIG. 3) in tuple 135I is indicative of total number of records (also called “rows”) classified in category X that identify person 181I. For example, if category X is “meals” and person 181I is John Doe, number v1 (FIG. 3) in tuple 135I may be indicative of total number of expense-reimbursement requests by John Doe that are for meals and were incurred in cash.

A second number v2 (FIG. 3) in tuple 135I is indicative of a total number of rows classified in category X that identify person 181I and which satisfy a specific test P. So, if the test P is to check the amount for being within a predetermined range (selected by user 183 of FIG. 2, based on a predetermined approval limit), in the above-described example number v2 in tuple 135I may be indicative of total number of expense-reimbursement requests by John Doe that are for meals and incurred in cash and whose amount is in a first predetermined range for meals (e.g. the range $20-$35, wherein $35 is the approval limit for meals).

A third number v2 (FIG. 3) in tuple 135I is indicative of a total number of rows classified in category X that identify person 181I and which satisfy a specific test Q. So, if the test Q is to check a last digit of the amount for round value (0 or 5), in the above-described example number v3 in tuple 135I may be indicative of total number of expense-reimbursement requests by John Doe that are for meals and incurred in cash and whose amount ends in 0 or 5 as the last digit.

A fourth number v4 (FIG. 3) in tuple 135I is indicative of total number of records classified in category Y that identify person 181I. For example, if category Y is “car rental”, number v4 (FIG. 3) in tuple 135I may be indicative of total number of expense-reimbursement requests by John Doe that are for car rental.

A fifth number v5 (FIG. 3) in tuple 135I is indicative of a total number of rows classified in category Y that identify person 181I and which satisfy the above-described specific test P (also used for second number v2). Hence, in the above-described example number v5 in tuple 135I may be indicative of total number of expense-reimbursement requests by John Doe that are for car rental and incurred in cash and whose amount is in a second predetermined range for car rentals (e.g. the range $30-$40, wherein $40 is the approval limit for car rentals).

A sixth number v6 (FIG. 3) in tuple 135I is indicative of a total number of rows classified in category Y that identify person 181I and which satisfy the above-described specific test Q (also used for third number v3). In the above-described example number v6 in tuple 135I may be indicative of total number of expense-reimbursement requests by John Doe that are for car rental and incurred in cash and whose amount ends in 0 or 5 as the last digit.

A seventh number v7 (FIG. 3) in tuple 135I is indicative of total number of records classified in category Z that identify person 181I. For example, if category Z is “hotel”, number v7 (FIG. 3) in tuple 135I may be indicative of total number of expense-reimbursement requests by John Doe that are for hotel.

An eighth number v8 (FIG. 3) in tuple 135I is indicative of a total number of rows classified in category Z that identify person 181I and which satisfy the above-described specific test P (also used for second number v2 and fifth number v5). Hence, in the above-described example number v8 in tuple 135I may be indicative of total number of expense-reimbursement requests by John Doe that are for hotel and incurred in cash and whose amount is in a third predetermined range for hotel (e.g. the range $70-$90, wherein $90 is the approval limit for hotel).

A ninth number v9 (FIG. 3) in tuple 135I is indicative of a total number of rows classified in category Z that identify person 181I and which satisfy the above-described specific test Q (also used for third number v3 and sixth number v6). In the above-described example number v9 in tuple 135I may be indicative of total number of expense-reimbursement requests by John Doe that are for hotel and incurred in cash and whose amount ends in 0 or 5 as the last digit.

In some embodiments, a computer 100 is programmed to perform the acts 411-423 illustrated in FIG. 4A, as described below. Specifically, in act 411, rows of expense-reimbursement requests that are to be analyzed together are retrieved by computer 100, e.g. from an expense report object 150 on hard disk 140 and/or from a table 191 in a relational database 190 that is accessible through a relational database management system (RDBMS) 1905 (FIG. 5B). The rows that are retrieved by computer 100 in act 411 may be filtered by use of one or more criteria, such as a date range (e.g. expense-reimbursement requests submitted in the first quarter of 2011), made in cash, and classified into user-specified categories (e.g. meals, car rental, housing). Depending on the embodiment, any other criteria (such as expense-reimbursement requests submitted by sales persons) may be used in act 411, either additionally or alternatively to the just-described criteria. Accordingly, a table in FIG. 4B illustrates rows that are retrieved in some embodiments, after performance of act 411.

Thereafter, in act 412, a nine dimensional vector v is created by computer 100 for each employee identified in the rows retrieved in act 411. In the example of rows shown in FIG. 4B, a vector for employee with ID of 3994596 is illustrated in FIG. 4C. Specifically, in FIG. 4B, there are two rows, namely row 1 and row 12 which hold expense-reimbursement requests for meals, by employee ID 3994596, and for this reason first number v1 of vector v is set to 2 as shown in FIG. 4C. The amounts $35.93 and $5.94 in the two rows 1 and 12 are respectively above the upper limit $35 and below the lower limit $20 and therefore second number v2 of vector is set to 0. Also, neither of the two amounts $35.93 and $5.94 in the two rows 1 and 12 ends in 0 or 5 and therefore third number v3 of vector v is set to 0.

Similarly, there are two rows, namely row 11 and row 17 which hold expense-reimbursement requests for car rentals, by employee ID 3994596, and for this reason fourth number v4 of vector v is set to 2. Moreover, only one amount of an expense-reimbursement request for car rental by employee ID 3994596, namely the amount $39.19 in row 11 (FIG. 4B) falls within the range $30 and $40 and for this reason fifth number v5 of vector v is set to 1. Furthermore, only one amount of an expense-reimbursement request for car rental by employee ID 3994596, namely the amount $29.00 in row 17 (FIG. 4B) has the last digit of either 0 or 5 and for this reason sixth number v6 of vector v is set to 1.

Finally, there are four rows, namely row 5, row 9, row 13 and row 18 which hold expense-reimbursement requests for hotel, by employee ID 3994596, and for this reason seventh number v7 of vector v is set to 4. Moreover, only one amount of an expense-reimbursement request for hotel by employee ID 3994596, namely the amount $86.51 in row 18 (FIG. 4B) falls within the range $70 and $90 and for this reason eighth number v8 of vector v is set to 1. Furthermore, only no amount of an expense-reimbursement request for hotel by employee ID 3994596, has the last digit of either 0 or 5 and for this reason ninth number v9 of vector v is set to 0. Accordingly, vector v for employee ID 3994596 constitutes the nine numbers (2, 0, 0, 2, 1, 1, 4, 1, 0). In this manner, similar vectors for the other employee IDs are also prepared in act 412.

After vectors are prepared in act 412, in an act 413 a variable k is set by computer 100, e.g. to a value that is received as input from a person 183 (FIG. 2). Although in some embodiments, the value of k is set to user input in act 413 as just described, in other embodiments the value of k is calculated automatically by computer 100, using any predetermined method with or without user input. In some embodiments, the value of k is predetermined prior to act 413, e.g. hard-coded in software instructions.

Next, in act 414, each vector v prepared in act 411 is assigned to one of k clusters, e.g. randomly. Thereafter, in act 415, for each cluster a vector vm (also called “mean vector”) is calculated, using the vectors that were just assigned to the cluster (in act 414). Specifically, the mean vector vm is calculated one number at a time, e.g. by calculating an average (or mean) of first numbers v1 in all vectors within a particular cluster, followed by calculating the average of all the second numbers v2, and so on, until the averages for all nine numbers v1 . . . v9 are calculated and these nine averages then are used to form vector vm. Note that instead of calculating nine averages, nine medians (or nine modes) can be calculated in other embodiments, and used as the nine numbers in such a vector vm. Thereafter, in act 416, a distance of each vector from each cluster's mean vector vm is computed by computer 100, and the distances are used to identify which mean vector vm is closest. Then, in act 417, each vector is re-assigned by computer 100 to the cluster whose mean vector vm is closest, thereby to re-group the vectors in the k clusters.

Next, in act 418, computer 100 checks if there is any change in the clusters to which the vectors now belong (e.g. by comparing vectors in the clusters before act 417 and vectors in the clusters after act 417). If there is no change, then act 423 is performed, as described below. If a change is found in act 418, then act 419 is performed by computer 100. Specifically, in act 419 a loop-breaking condition is checked (e.g. a limit on the number of iterations and/or a limit on the duration spent in looping) and if the condition has not been reached then another iteration of acts 415-418 is performed by computer 100. At the end of iterations that are performed initially, some (but not all) vectors may be grouped into clusters that are appropriate for those vectors, and on further iteration almost all or in some cases all vectors belong to clusters appropriate for them, so finally after a sufficient number of iterations there is no transfer of vectors between clusters (also called “convergence”).

Convergence depends on several factors, and may not necessarily occur in a timely manner. Hence, when a loop-breaking condition is met in act 419 then act 420 is performed by computer 100 to check if the current value of k can be replaced by another value of k (e.g. by prompting person 183 to specify another value as per act 421, or retrieving from database 190 an alternative value for k stored therein, or by re-calculating another value of k using a different predetermined method than a previously-used method for calculating a current value of k), followed by performing another iteration of acts 413-419. If another value of k is not available in act 420, then execution of software 110 is terminated, with a message that is displayed to user 183 as per act 422.

After displaying the message in act 422, computer 100 may receive from user 183, user input that changes one or more user-input parameters that were initially provided to computer 100, such as the k-value, or user input that changes one of the tests used to prepare the vectors (or tuples), or user input that changes an identity of one or more categories. For example, user 183 may decide to replace the category “hotel” in the example illustrated in FIG. 4B with the category “books” and also change the approval limit for this category. On receiving such user input, computer 100 makes the user-requested changes, and restarts execution of software 110 (e.g. starts performing act 411). Hence, after message 422 is displayed one or more times to a user, eventually the user input to computer 100 becomes successful in selecting an appropriate set of features that are sufficient to obtain appropriate clustering of vectors, so that outlier vectors are identified, followed by marking of persons as engaging in behavior at risk of fraud or error those who submitted the transactions that were used in forming the vectors now identified as outliers.

When one or more user input parameters supplied to computer 100 are appropriate, the above-described iterations converge (e.g. after each new iteration, the vectors continue to be grouped in the same clusters as before that new iteration). On convergence, computer 110 performs act 423 to rank the final clusters (which are output by the most-recent iteration, or the last iteration), e.g. based on the number of vectors in each cluster. A cluster with the fewest vectors is thereafter used by computer 110 in act 424, marked as being indicative of persons whose behavior is inappropriate. Specifically, in some embodiments of act 424, each row (identifying a transaction) that was retrieved as input in act 411 is marked in memory 130, with one or two values of inappropriateness as follows. A first value that is marked for a transaction (or row or record) is a distance (described above) of the closest mean from the vector that includes a count derived from the row being marked. This distance forms an absolute indication of suspicious behavior by an employee, in submitting the transaction identified in the row. A second value is used to store a cluster number, which forms a relative indication of the employee's suspicious behavior.

In some embodiments, the above-described two values of inappropriateness are stored in database 190 as two additional columns (not shown) that are added to a table of the type shown in FIG. 4B. Either or both values of inappropriateness may be transmitted as per act 115 (FIG. 1) to computer 184 for display to person 183, as indications 153. Other additional columns (not shown) which may also be transmitted by computer 100 to computer 184 for display to user 183 with each transaction include, e.g. employee name, employee position, etc. and displayed in some embodiments on a display of computer 184 adjacent to either or both values of inappropriateness corresponding thereto.

Although the above description refers to a single computer 100, other embodiments may use multiple computers and/or multiple processors within a computer. For example, act 112 in FIG. 1 may be performed in a first computer to prepare a set of vectors (and so, this first computer implements a tuple creator 110A that performs act 112). The set of vectors may be electronically transferred to a second computer that performs act 113 in FIG. 1 (and so this second computer implements an outlier detector 110B that performs act 113). In such an example, act 114 may be performed in either of the first or second computers, or act 114 may be performed in a third computer, depending on the embodiment (and so this third computer implements a transaction marker 110C that performs act 114).

Transaction marker 110C may invoke an input logic 1905I to store a marking of a transaction and/or a marking of a person that submitted the transaction in a database 190. The input logic 1905I may be implemented in a fourth computer, also depending on the embodiment, and this fourth computer may additionally implement an output logic 1905O that performs act 111. Hence, act 111 may be performed in any of the just-described computers, or in a fifth computer, also depending on the embodiment. Therefore, as will be readily apparent to a skilled artisan in view of this detailed description, instructions of software 110 to perform a method of the type illustrated in FIG. 1 or FIG. 4A may be executed by one or computers and/or one or more processors and/or one or more cores within a processor, etc. Moreover, such software may be stored in one or more non-transitory computer-readable storage media of the type described below.

The method of FIG. 1 may be used to program one or more computers of the type illustrated in FIG. 5A which is discussed next. Specifically, computer 100 includes a bus 1102 (FIG. 5A) or other communication mechanism for communicating information, and a processor 120 coupled with bus 1102 for processing information. Computer 100 includes the above-described memory 130 (FIG. 2) such as a random access memory (RAM) or other dynamic storage device, coupled to bus 1102 for storing information and instructions (e.g. for the method of FIG. 1) to be executed by processor 120.

Main memory 130 also may be used for storing temporary variables or other intermediate information (e.g. clusters) during execution of instructions to be executed by processor 120. Computer 100 further includes a read only memory (ROM) 1104 or other static storage device coupled to bus 1102 for storing static information and instructions for processor 120, such as enterprise software 200. A storage device 1110, such as a magnetic disk or optical disk, is provided and coupled to bus 1102 for storing information and instructions.

Computer 100 may be coupled via bus 1102 to a display device or video monitor 1112 such as a cathode ray tube (CRT) or a liquid crystal display (LCD), for displaying information to a person, e.g. appropriateness of transactions may be displayed on display 1112. An input device 1114, including alphanumeric and other keys (e.g. of a keyboard), is coupled to bus 1102 for communicating information to processor 1105. Another type of user input device is cursor control 1116, such as a mouse, a trackball, or cursor direction keys for communicating information and command selections to processor 120 and for controlling cursor movement on display 1112. This input device typically has two degrees of freedom in two axes, a first axis (e.g., x) and a second axis (e.g., y), that allows the device to specify positions in a plane.

As described elsewhere herein, transactions analyzer 110 is implemented by computer 100 in response to processor 120 executing one or more sequences of one or more instructions that are contained in main memory 130. Such instructions may be read into main memory 130 from one or more non-transitory computer-readable storage media, such as storage device 1110. Execution of the sequences of instructions contained in main memory 130 causes one or more processors (such as processor 120) to perform the operations of a process of the type described herein, and illustrated in one or more of FIG. 1. In alternative embodiments, hard-wired circuitry may be used in place of or in combination with software instructions to implement the invention. Thus, embodiments of the invention are not limited to any specific combination of hardware circuitry and software.

The term “non-transitory computer-readable storage medium” as used herein refers to any non-transitory storage medium that participates in providing instructions to processor 120 for execution and/or data to processor 120 for use during execution. Such a non-transitory storage medium may take many forms, including but not limited to (1) non-volatile storage media, and (2) volatile storage media. Common forms of non-volatile storage media include, for example, a floppy disk, a flexible disk, hard disk, optical disk, magnetic disk, magnetic tape, or any other magnetic medium, a CD-ROM, any other optical medium, punch cards, paper tape, any other physical medium with patterns of holes, a PROM, and EPROM, a FLASH-EPROM, any other memory chip or cartridge that can be used as storage device 1110. Some non-volatile storage media write and read data using one or more magnetic heads, while other non-volatile storage media write and read data using lasers. Volatile storage media includes dynamic memory, such as main memory 130 which may be implemented in the form of a random access memory or RAM, such as DRAM.

Instructions to processor 120 can be provided by a transmission link or by a non-transitory storage medium from which a computer can read information, such as data and/or code. Specifically, various forms of transmission link and/or non-transitory storage medium may be involved in providing one or more sequences of one or more instructions to processor 120 for execution. For example, the instructions may initially be comprised in a non-transitory storage device, such as a magnetic disk, of a remote computer. The remote computer can load the instructions into its dynamic memory (e.g. RAM) and send the instructions over a telephone line using a modem.

A modem local to computer 100 can receive information about a change to a collaboration object on the telephone line and use an infra-red transmitter to transmit the information in an infra-red signal. An infra-red detector can receive the information carried in the infra-red signal and appropriate circuitry can place the information on bus 1102. Bus 1102 carries the information to main memory 1106, from which processor 1105 retrieves and executes the instructions. The instructions received by main memory 130 may optionally be stored on storage device 1110 either before or after execution by processor 120.

Computer 100 also includes a communication interface 1115 coupled to bus 1102. Communication interface 1115 provides a two-way data communication coupling to a network link 1120 that is connected to a local network 1122. Local network 1122 may interconnect multiple computers (as described above). For example, communication interface 1115 may be an integrated services digital network (ISDN) card or a modem to provide a data communication connection to a corresponding type of telephone line. As another example, communication interface 1115 may be a local area network (LAN) card to provide a data communication connection to a compatible LAN. Wireless links may also be implemented. In any such implementation, communication interface 1115 sends and receives electrical, electromagnetic or optical signals that carry digital data streams representing various types of information.

Network link 1120 typically provides data communication through one or more networks to other data devices. For example, network link 1120 may provide a connection through local network 1122 to a host computer 1125 or to data equipment operated by an Internet Service Provider (ISP) 1126. ISP 1126 in turn provides data communication services through the world wide packet data communication network 1124 now commonly referred to as the “Internet”. Local network 1122 and network 1124 both use electrical, electromagnetic or optical signals that carry digital data streams. The signals through the various networks and the signals on network link 1120 and through communication interface 1115, which carry the digital data to and from computer 100, are exemplary forms of carrier waves transporting the information.

Computer 100 can send messages and receive data, including program code, through the network(s), network link 1120 and communication interface 1115. In an Internet example, a computer 1100 might transmit and/or receive information stored in RDBMS database 190 (FIG. 2, FIG. 5B) through Internet 1124, ISP 1126, local network 1122 and communication interface 1115, and a read/write head of a magnetic disk in storage device 1110 (wherein database 190 may be stored in part or in whole). Software instructions for performing the operations of FIG. 1 may be executed by processor 120 as they are received, and/or stored in storage device 1110, or other non-volatile storage for later execution. In this manner, computer 100 may additionally or alternatively obtain instructions and any related data in the form of a carrier wave.

Note that FIG. 5A is a very low-level representation of many hardware components of a computer system. Several embodiments have one or more additional software components in main memory 130 as shown in FIG. 5B. Specifically, in such embodiments, computer 100 of FIG. 5A implements a relational database management system 1905 of the type illustrated in FIG. 5B. Relational database management system 1905 of some embodiments includes an input logic 1905I configured to store data in database 190 and an output logic 1905O configured to retrieve data from database 190. Relational database management system (RDBMS) 1905 may include additional logic to manage the operation of logics 1905I and 1905O, e.g. to operate as a distributed database system that includes multiple databases, each database 190 being stored on different storage mechanisms.

In some embodiments, multiple databases are made by RDBMS 1905 to appear to transactions analyzer 110 as a single database 190. In such embodiments, transactions analyzer 110 can access and modify the data in a database 190 via RDBMS 1905 that accepts queries (also called “commands”) in conformance with a relational database language, the most common of which is the Structured Query Language (SQL). Such relational database commands/queries are used by transactions analyzer 110 of some embodiments to store, modify and retrieve data about transactions in the form of rows in one or more tables, e.g. RDBMS tables, such as table 191 in database 190. Table 191 may be related to other tables in database 190, e.g. by one or more columns in table 191 that hold foreign keys indicative of rows of data in other tables in database 190.

As noted above, relational database management system 1905 includes input logic 1905O (FIG. 5B) that stores transactions and other data (such as marking of persons identified as submitting transactions that are at risk of error or fraud) in one or more such tables of database 190. Moreover, relational database management system 1905 includes output logic 1905O (FIG. 5B) that makes transactions and other data (such as persons marked as having submitted risky transactions as noted above) in one or more such tables of database 190 available to a user via a graphical user interface that generates a display on a video monitor 1112 (FIG. 5B) or on another computer such as host computer 1125 or computer 184 described above (see FIG. 2).

As noted above, in several embodiments, computer 100 (FIG. 5A) includes one or more memories 130, 1104, 1110 operatively coupled to one or more processors 120 with the processor(s) 120 being configured to execute software instructions in the one or more memories 130, 1104, 1110. Software instructions in the one or more memories, on being executed by the one or more processors 120, implement means for performing functions in some embodiments. In some embodiments means of the type described in below are included in an apparatus that contains dedicated circuitry, e.g. in application specific integrated circuits (ASICs) and/or field programmable gate arrays (FPGAs).

Examples of means that are used in some embodiments are as follows. In some embodiments, a means for retrieving from a database is implemented by at least an output logic 1905O of a relational database management system (RDBMS) 1905 that makes data available from database 190, in response to a SQL query. In certain embodiments, a means for automatically preparing is implemented by at least a tuple creator 110A (described above). Also in several embodiments, a means for automatically identifying is implemented by at least an outlier detector 110B (described above). Moreover, in some embodiments, means for automatically marking is implemented by at least a transaction marker 110C (described above). Also, in some embodiments, means for transmitting to a computer is implemented by at least a communication interface 1115. Furthermore, in some embodiments, a means for storing in a database is implemented by at least an input logic 1905I of a relational database management system (RDBMS) 1905 that stores data in database 190, in response to another SQL query. Also, in some embodiments, a means for receiving user input is implemented by at least an input device 1114 (e.g. keyboard and/or microphone) and/or cursor control 1115 (e.g. mouse and/or touchpad). Moreover, in some embodiments, a means for printing a check is implemented by at least a printer 1113.

In one example, the output logic 1905O provides results via a web-based user interface that depicts information related to transactions, by employees (or persons) whose tuples have been identified as outliers. Additionally and/or alternatively, a database-centric screen is responsive to a command in a command-line interface e.g. on input device 1114 (FIG. 5A) and displays on a video monitor, such as display 1112, text information on the employee (or person).

Numerous modifications and adaptations of the embodiments described herein will become apparent to the skilled artisan in view of this disclosure.

Numerous modifications and adaptations of the embodiments described herein are encompassed by the scope of the invention.

1. A method of processing transactions by using one or more computers, the method comprising:
the one or more computers retrieving a plurality of records of transactions to be analyzed together;
wherein each record in said plurality identifies at least an amount of a transaction, a person associated with the transaction, and a type of the transaction;
the one or more computers automatically preparing in computer memory, a set of tuples for a corresponding set of persons identified in the plurality of records;
wherein a tuple corresponding to said person comprises a group of numbers which are derived from transactions associated with said person, based on types of the transactions;
the one or more computers automatically identifying a subset of said tuples, by analysis of said set to detect outliers; and
the one or more computers automatically marking in said computer memory, an indication of inappropriateness based on at least one transaction whose associated person corresponds to at least one tuple in the subset.

2. The method of claim 1 further comprising:
the one or more computers transmitting to another computer, identification of at least said transaction marked with said indication of inappropriateness.

3. The method of claim 2 further comprising:
the one or more computers receiving user input to approve payment of another transaction identified in the plurality of records; and
the one or more computers printing a check for another amount of said another transaction, based on said user input.

4. The method of claim 1 wherein:
at least a common predetermined test is used to derive a first number in the group, based on a first type among said types; and
at least said common predetermined test is additionally used to derive a second number in the group, based on a second type among said types; and
each transaction is an expense.

5. The method of claim 4 wherein:
the common predetermined test uses a last digit of the amount.

6. The method of claim 4 wherein:
a first additional predetermined test based on a first approval limit on the amount is additionally used in deriving the first number, based on transactions of the first type; and
a second additional predetermined test based on a second approval limit on the amount is additionally used in deriving the second number, based on transactions of the second type.

7. The method of claim 1 wherein:
a first number in the group of numbers is indicative of a count of transactions of a first type associated with said person that satisfy a predetermined test; and
a second number in the group of numbers is indicative of total number of transactions of the first type associated with said person.

8. The method of claim 1 wherein the one or more computers automatically identifying the subset comprises:
the one or more computers assigning each tuple to one of k clusters;
the one or more computers computing a mean of tuples in each of the k clusters;
the one or more computers computing a distance of each tuple from the mean of each of the k clusters; and
the one or more computers re-assigning each tuple to a cluster whose mean is closest to said each tuple;
wherein said at least one tuple in the set identified as the outlier is comprised in the cluster with fewest tuples relative to other clusters among the k clusters.

9. One or more non-transitory computer-readable storage media comprising a plurality of instructions to cause a computer comprising a memory to:
retrieve from a relational database, a plurality of records of transactions to be analyzed together;
wherein each record in said plurality identifies at least an amount of a transaction, a person associated with the transaction, and a type of the transaction;
automatically prepare in said memory, a set of tuples corresponding to a set of persons identified in the plurality of records;
wherein a tuple corresponding to said person comprises a group of numbers which are derived from transactions associated with said person, based on types of the transactions;
automatically identify a subset of said tuples, by analysis of said set to detect outliers; and
automatically mark in said memory, an indication of inappropriateness based on at least one transaction from which is derived a number in at least one tuple in the subset.

10. The one or more non-transitory computer-readable storage media of claim 9 further comprising:
instructions to said computer to transmit to another computer, identification of at least said transaction marked with said indication of inappropriateness.

11. The one or more non-transitory computer-readable storage media of claim 9 further comprising:
instructions to said computer to receive user input to approve payment of another transaction identified in the plurality of records; and
instructions to said computer to print a check for another amount of another transaction comprised in said subset, based on said user input.

12. The one or more non-transitory computer-readable storage media of claim 9 wherein:
at least a common predetermined test is used to derive a first number in the group, based on a first type among said types; and
at least said common predetermined test is additionally used to derive a second number in the group, based on a second type among said types; and
each transaction is an expense.

13. The one or more non-transitory computer-readable storage media of claim 12 wherein:
the common predetermined test uses a last digit of the amount.

14. The one or more non-transitory computer-readable storage media of claim 9 wherein:
a first number in the group of numbers is indicative of a first count of transactions associated with said person in a first category that satisfy a predetermined test;
a first number in the group of numbers is indicative of a count of transactions of a first type associated with said person that satisfy a predetermined test; and
a second number in the group of numbers is indicative of total number of transactions of the first type associated with said person.

15. The one or more non-transitory computer-readable storage media of claim 9 wherein the instructions to automatically identify the subset comprise:
instructions to assign each tuple to one of k clusters;
instructions to compute a mean of tuples in each of the k clusters;
instructions to compute a distance of each tuple from the mean of each of the k clusters; and
instructions to re-assign each tuple to a cluster whose mean is closest to said each tuple;
wherein said at least one tuple in the set identified as the outlier is comprised in the cluster with fewest tuples relative to other clusters among the k clusters.

16. An apparatus for processing transactions, the apparatus comprising:
a memory and a processor; and
the apparatus further comprising:
means for retrieving a plurality of records of transactions to be analyzed together;
wherein each record in said plurality identifies at least an amount of a transaction, a person associated with the transaction, and a type of the transaction;
means for automatically preparing in computer memory, a set of tuples for a corresponding set of persons identified in the plurality of records;
wherein a tuple corresponding to said person comprises a group of numbers which are derived from transactions associated with said person, based on types of the transactions;
means for automatically identifying a subset of said tuples, by analysis of said set to detect outliers; and
means for automatically marking in said computer memory, an indication of inappropriateness based on at least one transaction from which is derived a number in at least one tuple in the subset.

17. The apparatus of claim 16 further comprising:
means for transmitting to a computer, identification of at least said transaction marked with said indication of inappropriateness;
means for receiving user input to approve payment of another transaction identified in the plurality of records; and
means for printing a check for another amount of another transaction comprised in said subset, based on said user input.

18. The apparatus of claim 16 wherein:
at least a common predetermined test is used to derive a first number in the group, based on a first type among said types; and
at least said common predetermined test is additionally used to derive a second number in the group, based on a second type among said types; and
each transaction is an expense.

19. The apparatus of claim 18 wherein:
the common predetermined test uses a last digit of the amount.

20. (canceled)

21. The method of claim 1 wherein:
during the retrieving, the plurality of records are retrieved from a relational database;
the types of the transactions comprise at least meals and mileage; and
a map is used to identify at least a location of each number in the tuple.
